(19) United States
(12) Patent Application Publication
(10) Pub. No.: US 2018/0000673 A1
(43) Pub. Date: Jan. 4, 2018

(54) Patient Support Systems With Rotary Actuators

(71) Applicant: Stryker Corporation, Kalamazoo, MI (US)

(72) Inventor: Gary L. Bartley, Kalamazoo, MI (US)

(73) Assignee: Stryker Corporation, Kalamazoo, MI (US)

(21) Appl. No.: 15/635,787

(22) Filed: Jun. 28, 2017

Related U.S. Application Data
(60) Provisional application No. 62/356,351, filed on Jun. 29, 2016.

(51) Int. Cl. A61G 7/018; A61G 7/005; A61G 7/012; A61G 7/05; A61G 7/015

(52) U.S. Cl. CPC A61G 7/018; A61G 7/0506; A61G 7/015; A61G 7/012; A61G 7/0516; A61G 7/0513; A61G 7/0524; A61G 7/005

(57) ABSTRACT

A patient support system comprises a patient support apparatus for patients. The patient support apparatus comprises a base and a patient support surface supported by the base. The patient support apparatus also comprises movable members that are movable between at least a first position and a second position. One or more rotary actuators are coupled to each movable member. The rotary actuator permits drive torque to move the movable member in a desired position between the first and second positions and restricts back drive torque from moving the movable member.

### RELATED APPLICATIONS

This application claims the benefit of and priority to U.S. Provisional Patent Application No. 62/356,351, filed on Jun. 29, 2016, the entire contents and disclosure of which are hereby incorporated by reference herein in their entirety.

### BACKGROUND

Patient support systems facilitate care of patients in a health care setting. Patient support systems comprise patient support apparatuses such as, for example, hospital beds, stretchers, cots, and wheelchairs. Conventional patient support apparatuses comprise a base and a patient support surface upon which the patient is supported. Often, these patient support apparatuses also have movable members such as lift members, patient support deck sections, a bed length extension member, a bed width extension member, a wheel, a side rail, a footboard, or a headboard. One or more of these movable members may be moved using actuators. Typically, in order to move these movable members, linear actuators are used. Linear actuators take up a large and undesirable amount of space within or beneath the patient support apparatus. Rotary actuators may also be used to move the movable members. Rotary actuators often encounter difficulty preventing movable members from back driving and going into undesirable positions in certain situations, such as during a loss of power or when components break. Additionally, rotary actuators generally lack stiffness to give a caregiver or patient confidence in the structural integrity of the rotary actuator.

A patient support apparatus designed to overcome one or more of the aforementioned challenges is desired.

### BRIEF DESCRIPTION OF THE DRAWINGS

FIG. 1 is a perspective view of a patient support apparatus.

FIG. 2 is a perspective view of a patient support deck in a first position.

FIG. 3 is a perspective view of the patient support deck in a second position.

FIG. 4 is a perspective view of a first embodiment of an actuator coupled to a seat section and a fowler section of the patient support deck.

FIG. 5 is another perspective view of the first embodiment of the actuator coupled to the seat section and the fowler section of the patient support deck.

FIG. 6 is a perspective view of the first embodiment of a compound epicyclic gear train with a movable member and an array of planet gear clusters.

FIG. 7 is another perspective view of the first embodiment of the compound epicyclic gear train with the movable member and the array of planet gear clusters.

FIG. 8 is a perspective view of the first embodiment of a carrier housing an array of planet gear clusters and a sun gear.

FIG. 9 is another perspective view of the first embodiment of the carrier housing the array of planet gear clusters and the sun gear.

FIG. 10 is a perspective view of the first embodiment of planet gear shafts coupled to the array of planet gear clusters.

FIG. 11 is another perspective view of the first embodiment of the planet gear shafts coupled to the array of planet gear clusters.

FIG. 12 is an elevational view of the compound epicyclic gear train and the movable member in a first position.

FIG. 13 is an elevational view of the compound epicyclic gear train and the movable member in a second position.

FIG. 14 is a perspective view illustrating a cross-section of the first embodiment of the compound epicyclic gear train.

FIG. 15 is an elevational view illustrating various locations the actuator may be coupled.

FIG. 16 is an elevational view illustrating a lift arm slidably coupled to a base of a patient support apparatus.

FIG. 17 is an elevational view illustrating one embodiment of where the actuator may be coupled.

FIG. 18 is an elevational view illustrating another embodiment of where the actuator may be coupled.

FIG. 19 is an elevational view illustrating the actuator coupled to a bed length extension device.

FIG. 20 is an elevational view illustrating the actuator coupled to a bed width extension device.

### DETAILED DESCRIPTION

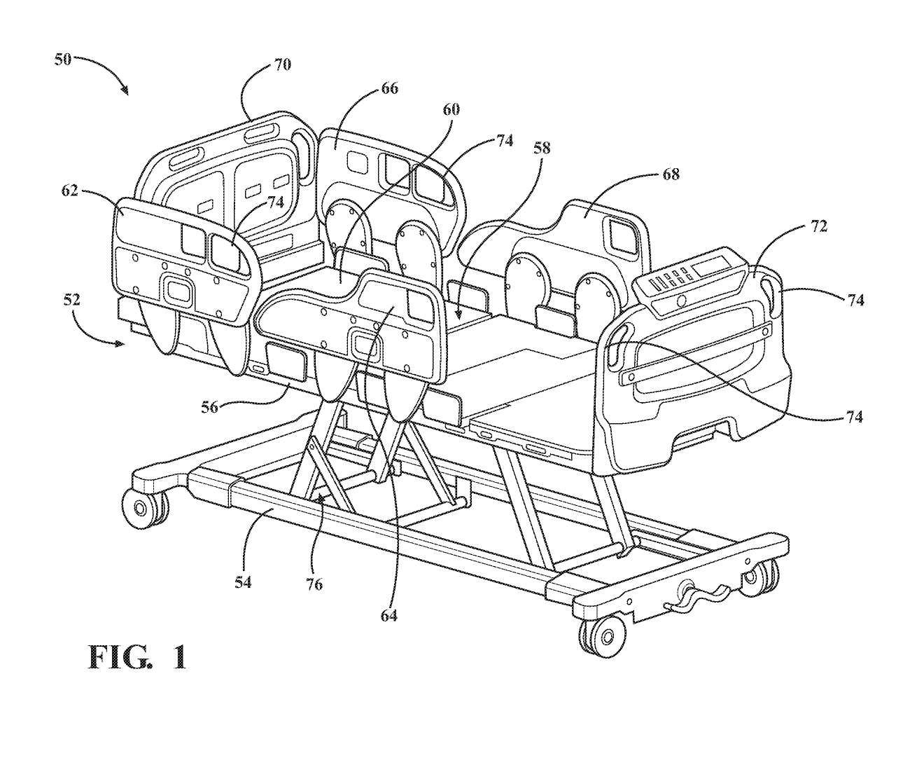

Referring to FIG. 1, a patient support system comprising a patient support apparatus 50 is shown for supporting a patient in a health care setting. The patient support apparatus 50 illustrated in FIG. 1 comprises a hospital bed. In other embodiments, however, the patient support apparatus 50 may comprise a stretcher, cot, table, wheelchair, or similar apparatus utilized in the care of a patient.

A support structure 52 provides support for the patient. The support structure 52 illustrated in FIG. 1 comprises a base 54 and an intermediate frame 56. The intermediate frame 56 is spaced above the base 54. The support structure 52 also comprises a patient support deck 58 disposed on the intermediate frame 56. The patient support deck 58 comprises several sections, some of which are pivotable relative to the intermediate frame 56, such as a fowler section, a seat section, a thigh section, and a foot section. The patient support deck 58 provides a patient support surface 60 upon which the patient is supported.

A mattress (not shown) is disposed on the patient support deck 58. The mattress comprises a secondary patient support surface upon which the patient is supported. The base 54, intermediate frame 56, patient support deck 58, and patient support surfaces 60 each have a head end and a foot end corresponding to designated placement of the patient's head and feet on the patient support apparatus 50. The construction of the support structure 52 may take on any known or conventional design, and is not limited to that specifically set forth above. In addition, the mattress may be omitted in certain embodiments, such that the patient rests directly on the patient support surface 60.

Side rails 62, 64, 66, 68 are coupled to the intermediate frame 56 and thereby supported by the base 54. A first side rail 62 is positioned at a right head end of the intermediate frame 56. A second side rail 64 is positioned at a right foot end of the intermediate frame 56. A third side rail 66 is positioned at a left head end of the intermediate frame 56. A fourth side rail 68 is positioned at a left foot end of the intermediate frame 56. If the patient support apparatus 50 is a stretcher or a cot, there may be fewer side rails. The side rails 62, 64, 66, 68 are movable between a raised position in which they block ingress and egress into and out of the patient support apparatus 50, a lowered position in which they are not an obstacle to such ingress and egress, and/or one or more intermediate positions therebetween. In still other configurations, the patient support apparatus 50 may not include any side rails.

A headboard 70 and a footboard 72 are coupled to the intermediate frame 56. In other embodiments, when the headboard 70 and footboard 72 are included, the headboard 70 and footboard 72 may be coupled to other locations on the patient support apparatus 50, such as the base 54. In still other embodiments, the patient support apparatus 50 does not include the headboard 70 and/or the footboard 72.

Caregiver interfaces 74, such as handles, are shown integrated into the footboard 72 and side rails 62, 64, 66, 68 to facilitate movement of the patient support apparatus 50 over floor surfaces. Additional caregiver interfaces 74 may be integrated into the headboard 70 and/or other components of the patient support apparatus 50. The caregiver interfaces 74 are graspable by the caregiver to manipulate the patient support apparatus 50 for movement. In other embodiments, the patient support apparatus 50 does not include caregiver interfaces 74.

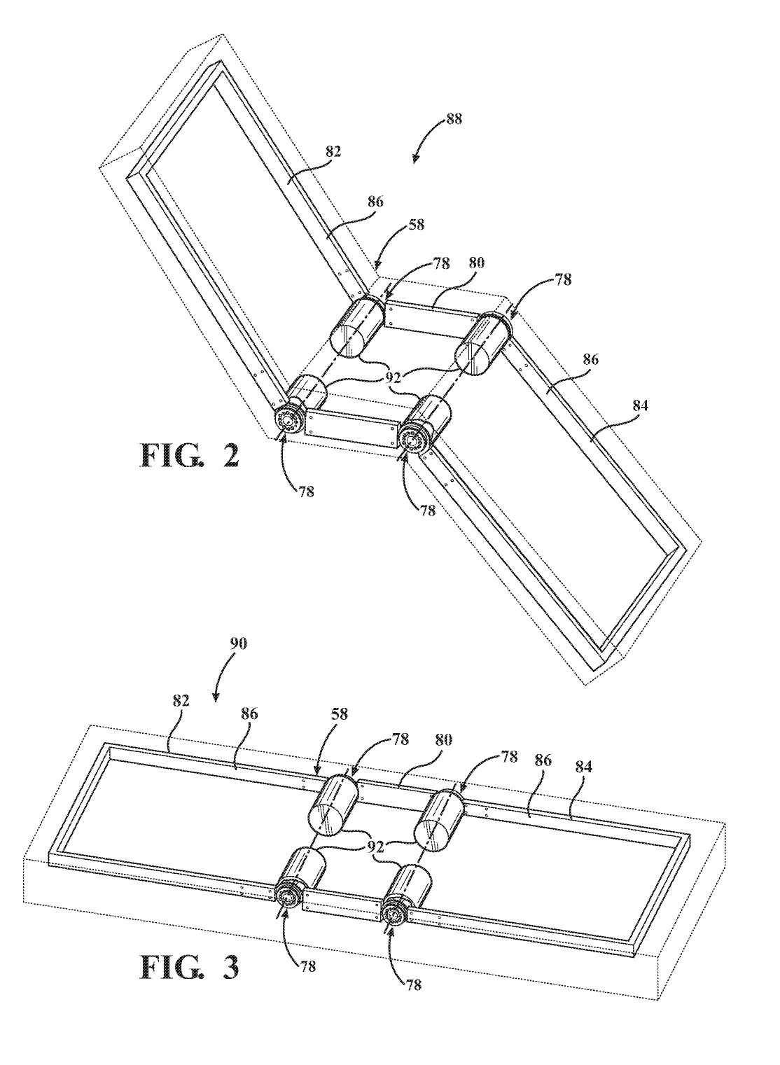

The patient support apparatus 50 may have numerous devices that comprise one or more movable members to perform a desired function. One such device is a lift device 76 that is coupled to the base 54 and the intermediate frame 56 to lift and lower the patient between minimum and maximum heights of the patient support apparatus 50, and/or intermediate positions therebetween. In the embodiment shown, the lift device 76 comprises a movable member in the form of a lift member for effectuating height changes of the patient support apparatus 50. Additionally, the patient support apparatus 50 may have other devices that comprise one or more movable members to perform a desired function such as a deck adjustment device configured to raise and/or lower one or more of the patient support deck sections. The movable members in these devices may be movable relative to another fixed or stationary member of the patient support apparatus 50 or movable relative to another member that also is movable. In some cases, the base 54 and/or the intermediate frame 56 may comprise the movable members. In these devices, one or more actuators 78 (see FIG. 2) are supported by the support structure 52. The actuators 78 are coupled to one or more of the movable members supported by the support structure 52. The movable member is any member supported by the support structure 52 and movable relative to any other member on the patient support apparatus 50, wherein the other member can include stationary or fixed members, or movable members.

Although many different placements and uses of the actuators 78 are possible on a single patient support apparatus 50, only certain illustrative embodiments will be described in detail. In one embodiment shown in FIGS. 2-5, the patient support deck 58 comprises a seat section 80 supported by the base 54. The patient support deck 58 further comprises a fowler section 82 movably coupled to the seat section 80 and a foot section 84 movably coupled to the seat section 80 independent of the fowler section 82. In some embodiments, the seat section 80 is fixed to the intermediate frame 56. Actuators 78 are disposed between each of the fowler 82, foot 84, and seat 80 sections and are configured to move the fowler 82 and foot 84 sections relative to the seat section 80. In this embodiment, the fowler 82 and foot 84 sections comprise movable members 86 movable between at least a first position 88 shown in FIG. 2, a second position 90 shown in FIG. 3, and other positions therebetween. The fowler 82 and foot 84 sections may move concurrently or independently of each other. Four actuators 78 are shown, one for each movable member 86, but one actuator 78 could be employed to move a pair of the movable members 86, such that only one actuator 78 is employed to move each of the fowler section 82 and the foot section 84.

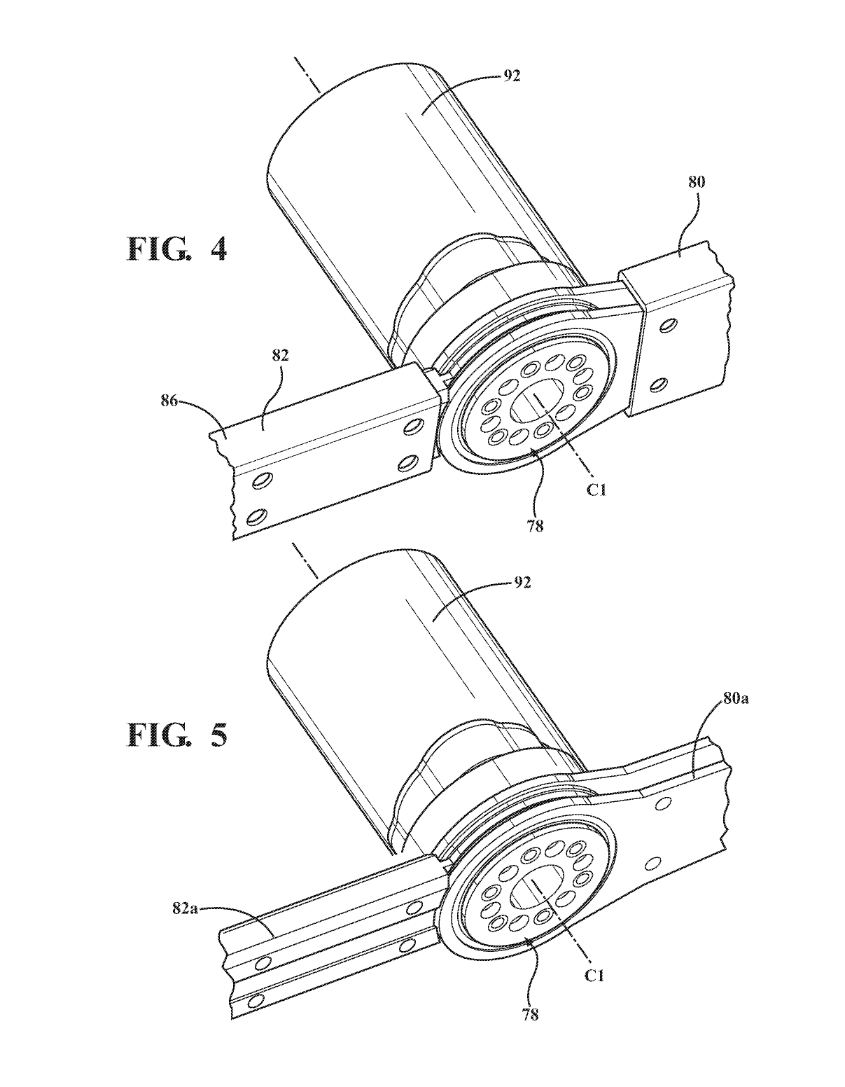

As shown in FIGS. 4 and 5, only one of the actuators 78 between the fowler section 82 and the seat section 80 is described herein for ease of description. In many of the embodiments disclosed below, the movable member 86 of the fowler section 82 is described for convenience. The movable member 86 is coupled to the actuator 78. The actuator 78 comprises a motor 92. The motor 92 provides power for the actuator 78. The motor 92 may be an electric motor, a hydraulic motor, or any other motor adapted to provide power for the actuator 78. The actuator 78 shown in FIGS. 4 and 5 is arranged to pivot the fowler section 82 relative to the seat section 80 about center axis C1. FIG. 4 shows the seat and fowler sections 80, 82 and FIG. 5 shows arms 80a, 82a of the actuator 78 that are connected to the seat and fowler sections 80, 82, respectively. At least one of the arms is intended to articulate relative to the other to cause movement. In the embodiment shown, the arm 82a articulates relative to the arm 80a to move the fowler section 82 relative to the seat section 80.

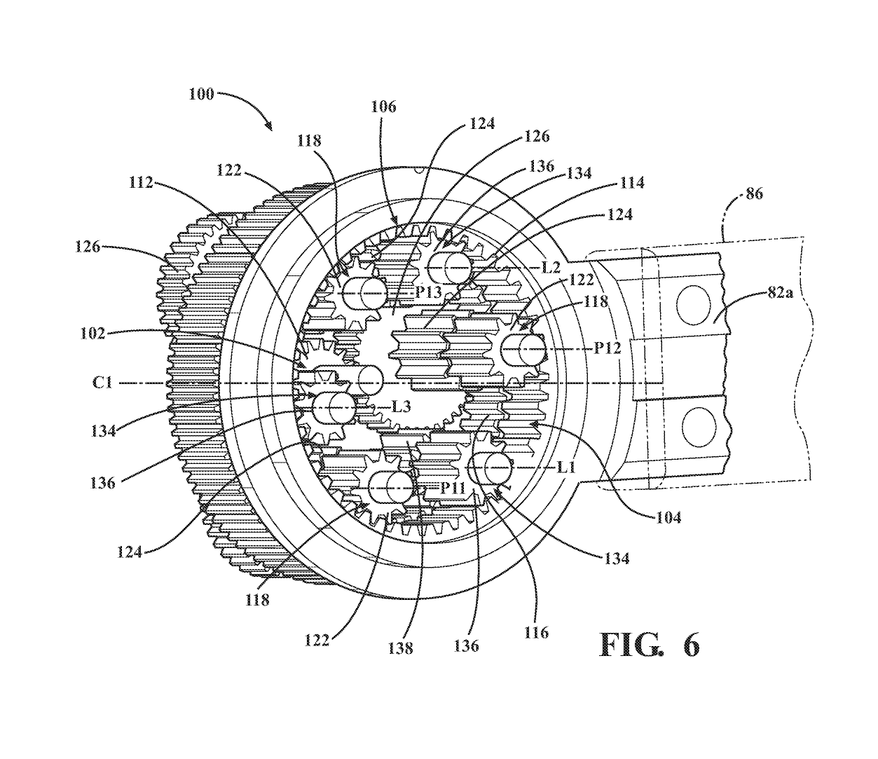

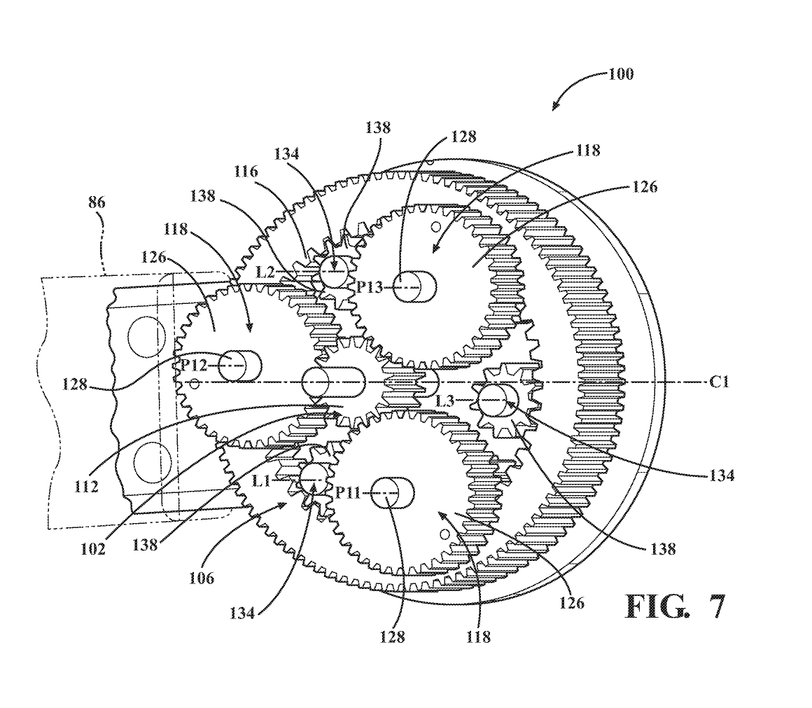

In one embodiment shown in FIGS. 6 and 7, the actuator 78 comprises a gear assembly 100 having an input member 102, an output member 104 connected to the movable member 86, and a gear arrangement 106 operable between the input member 102 and the output member 104. The motor 92 (not shown in FIGS. 6 and 7) is coupled to the input member 102 to rotate the input member 102 and provides power for the actuator 78. Power from the motor 92 translates to torque that is transmitted to the input member 102, through the gear arrangement 106, and results in rotation of the output member 104 to drive movement of the movable member 86. The motor 92 can be mounted to the movable member 86 or other component of the patient support apparatus 50. In some cases, the motor 92 is mounted to a component of the gear assembly 100 or a housing of the actuator 78.

It should be noted that in many of the figures described herein (like FIGS. 6 and 7) certain components of the actuator 78 and its gear assembly 100 have been removed for convenience of description and ease of illustration. Additionally, bearings, bushings or other members used to rotatably support parts of the gear assembly 100 are shown in the figures, but not described in detail as their utilization and function are well understood by those skilled in the art.

The input member 102, output member 104, and gear arrangement 106 collectively form a compound epicyclic gear train. One advantage of the compound epicyclic gear train is the relatively small size of the compound epicyclic gear train compared to conventional linear actuators or similar devices.

In one embodiment, the input member 102 comprises a sun gear 112 rotatable about the center axis C1. The sun gear 112 is fixed to an input member shaft coupled to the motor 92. The output member 104 comprises a first ring gear, hereinafter referred to as a moving ring gear 114 rotatable about the center axis C1. The gear arrangement 106 comprises a second ring gear, hereinafter referred to as a fixed ring gear 116 disposed about the center axis C1. The gear arrangement 106 further comprises an array of planet gear clusters 118 disposed in direct meshing relationship with each of the sun gear 112, moving ring gear 114, and fixed ring gear 116. The fixed ring gear 116 is fixed about the center axis C1 and the moving ring gear 114 rotates relative to the fixed ring gear 116 about the center axis C1. In one embodiment, the fixed ring gear 116 is fixed to the seat section 80. It should be appreciated that the fixed ring gear 116 could be connected to another movable member 86 such that the actuator 78 is merely providing relative motion between two movable members 86.

In another embodiment, the sun gear 112 is rotatable about a sun gear axis spaced from the center axis C1 and the gear arrangement 106 comprises a third ring gear disposed about the center axis C1. The sun gear 112 is disposed in direct meshing relationship with the third ring gear and the third ring gear is disposed in direct meshing relationship with the array of planet gear clusters 118. The sun gear 112 is configured to transmit rotational power received from the motor 92 through the sun gear 112 and the third ring gear to the array of planet gear clusters 118.

In alternative embodiments, instead of the moving ring gear 114 being connected to the movable member 86, another part of the gear assembly 100 could be connected to the movable member 86 to move the movable member 86. In this case, the other part would be considered the output member, as the output member comprises the part of the actuator 78 that is connected to the movable member 86. For instance, the moving ring gear 114, instead of being connected to the movable member 86, could be fixed to the seat section 80 and the fixed ring gear 116 could be connected to the movable member 86 to move the movable member 86 (e.g., making the fixed ring gear 116 the output member 104).

Referring briefly to FIGS. 2-4, the movable member 86 of the fowler section 82 is coupled to the moving ring gear 114 and the seat section 80 is fixed to the fixed ring gear 116. In the shown embodiments, the moving ring gear 114 is mounted to the movable member 86 by virtue of the arm 82a, which is integrally formed with the moving ring gear 114. In this manner, the actuator 78 accommodates movement of the fowler section 82 relative to the seat section 80 about the center axis C1. In other embodiments, the moving ring gear 114 may be integral with the movable member 86 or may be otherwise attached to the movable member 86 in any other suitable manner.

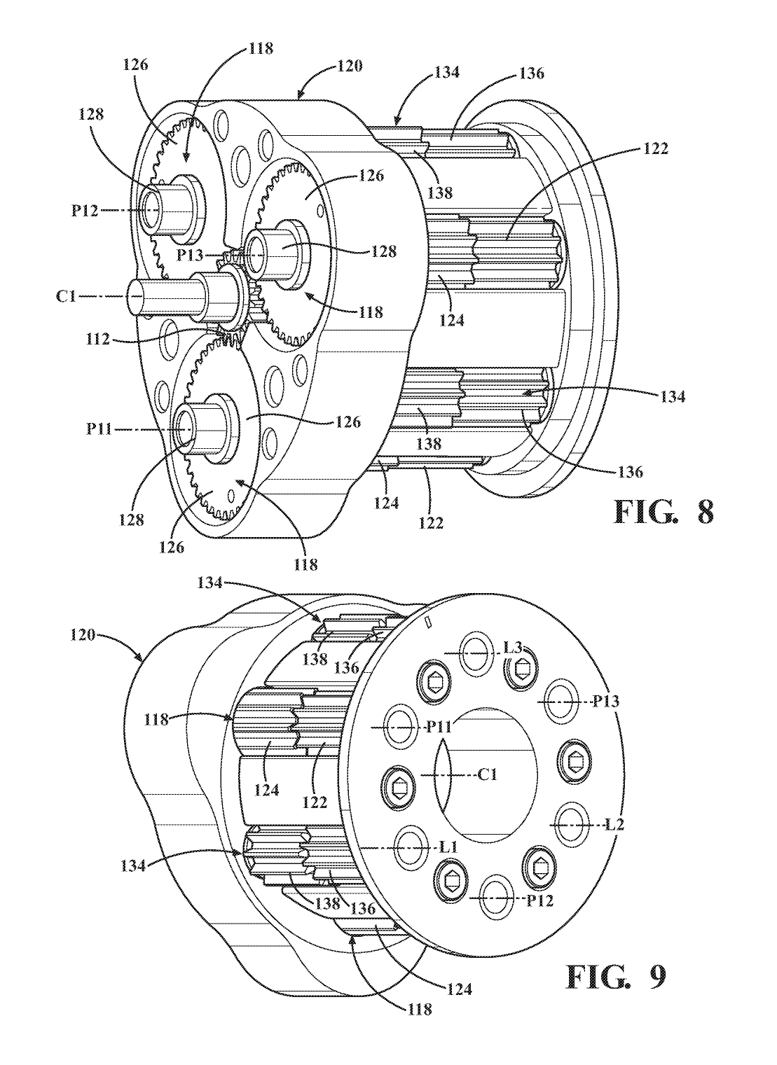

Referring to FIGS. 8 and 9, the compound epicyclic gear train comprises a carrier 120 rotatable about the center axis C1. The carrier 120 is a housing which retains the array of planet gear clusters 118 in direct meshing relationship with each of the sun gear 112, the moving ring gear 114 (removed in FIGS. 8 and 9), and the fixed ring gear 116 (removed in FIGS. 8 and 9) as the carrier 120 rotates about the center axis C1 by virtue of the planetary motion of the array of planet gear clusters 118. In some embodiments, the carrier 120 comprises multiple components coupled together to form a single housing for ease in assembling the actuator 78. In other embodiments, the carrier 120 is one piece. In some cases, the carrier 120 could be mounted on the patient support apparatus 50 (such as on the intermediate frame 56) with both ring gears 114, 116 moving relative to the carrier 120, and both ring gears 114, 116 connected to different movable members 86, making both of the ring gears 114, 116 output members 104.

The array of planet gear clusters 118 comprises first planet gears 122 spaced from each other and rotatable about respective planet gear axes P11, P12, P13. Each of the first planet gears 122 is disposed in direct meshing relationship with the moving ring gear 114. The first planet gears 122 revolve about the center axis C1 during actuation. In many embodiments, the planet gear axes P11, P12, P13 are parallel with the center axis C1.

The array of planet gear clusters 118 comprises second planet gears 124 fixed to the first planet gears 122 to rotate with the first planet gears 122 about the planet gear axes P11, P12, P13 and to revolve with the first planet gears 122 about the center axis C1. Each of the second planet gears 124 is disposed in direct meshing relationship with the fixed ring gear 116.

The array of planet gear clusters 118 comprises three first planet gears 122 and three second planet gears 124. In some embodiments, the array of planet gear clusters 118 comprises two or more of the first planet gears 122 and two or more of the second planet gears 124. In other embodiments, the array of planet gear clusters 118 comprises one first planet gear 122 and one second planet gear 124.

The array of planet gear clusters 118 comprises third planet gears 126 fixed to the first 122 and second 124 planet gears to rotate with the first 122 and second 124 planet gears about the planet gear axes P11, P12, P3 and to revolve with the first 122 and second 124 planet gears about the center axis C1. Each of the third planet gears 126 is disposed in direct meshing relationship with the sun gear 112.

The array of planet gear clusters 118 comprises three third planet gears 126. In some embodiments, the array of planet gear clusters 118 comprises two or more third planet gears 126. In other embodiments, the array of planet gear clusters 118 comprises one third planet gear 126. The planet gears 122, 124, 126 are all supported for rotation within the carrier 120. Further, by virtue of being rotatably supported in the carrier 120, the carrier 120 revolves together with the planet gears 122, 124, 126 about the center axis C1 during actuation.

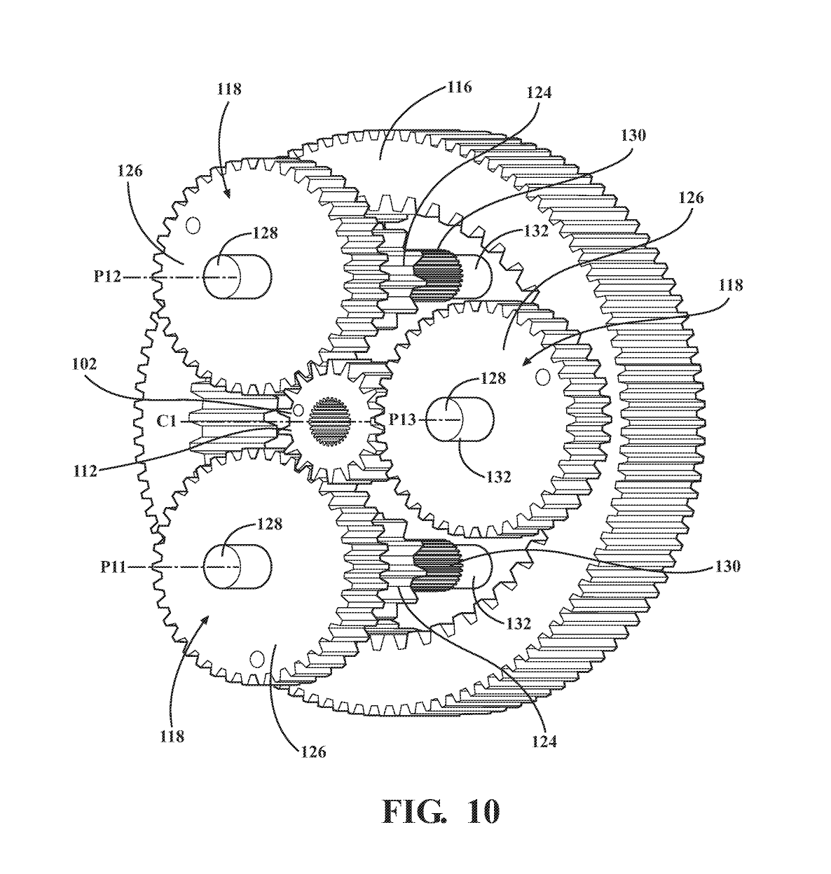

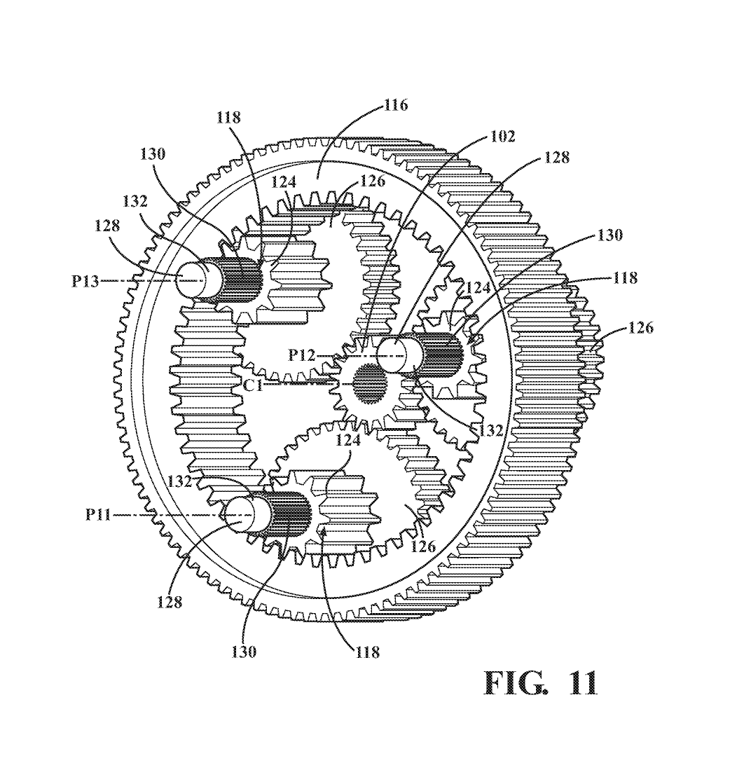

As shown in FIGS. 10 and 11, planet gear shafts 128 are disposed along the planet gear axes P11, P12, P13 and are used to couple the first 122, second 124, and third planet 126 gears together. Each shaft 128 defines a length and may comprise a spline 130 disposed on an exterior surface 132 of the shaft 128. Each spline 130 extends along a partial length of each shaft 128 to align the first 122, second 124, and third 126 planet gears in a desired rotational orientation relative to each other. The first planet gear 122 has been removed in FIGS. 10 and 11 from the array of planet gear clusters 118 in order to illustrate one embodiment of the spline 130. In alternative embodiments, each spline 130 only aligns one or two of each of the first 122, second 124, and third 126 planet gears in a desired rotational orientation and the remaining first 122, second 124, or third 126 planet gears are aligned to each shaft 128 in an alternative method including, but not limited to, welding, press-fitting, or use of a pin. In still other embodiments, each shaft 128, first planet gear 122, second planet gear 124, and third planet gear 126 are integrated such that they collectively form a single component.

Referring back to FIGS. 6 and 7, the compound epicyclic gear train comprises an array of load-sharing planet gear clusters 134. The array of load-sharing planet gear clusters 134 comprises first load-sharing planet gears 136 spaced from each other and rotatable about respective load-sharing planet gear axes L1, L2, L3. Each of the first load-sharing planet gears 136 is disposed in direct meshing relationship with the moving ring gear 114 and revolve about the center axis C1. In many embodiments, the load-sharing planet gear axes L1, L2, L3 are parallel with the center axis C1.

The array of load-sharing planet gear clusters 134 comprises second load-sharing planet gears 138 fixed to the first load-sharing planet gears 136 to rotate with the first load-sharing planet gears 136 about the load-sharing planet gear axes L1, L2, L3 and to revolve with the first load-sharing planet gears 136 about the center axis C1. Each of the second load-sharing planet gears 138 is disposed in direct meshing relationship with the fixed ring gear 116.

The array of load-sharing planet gear clusters 134 comprises three first load-sharing planet gears 136 and three second load-sharing planet gears 138. In some embodiments, the array of load-sharing planet gear clusters 134 comprises more than three first load-sharing planet gears 136 and more than three second load-sharing planet gears 138. In other embodiments, the array of load-sharing planet gear clusters 134 comprises fewer than three first load-sharing planet gears 136 and fewer than three second load-sharing planet gears 138. In still other embodiments, the compound epicyclic gear train does not include an array of load-sharing planet gear clusters 134.

The carrier 120 retains the first load-sharing planet gears 136 in direct meshing relationship with the moving ring gear 114 and retains the second load-sharing planet gears 138 in direct meshing relationship with the fixed ring gear 116. Further, the carrier 120 supports the load-sharing planet gears 136, 138 similar to the planet gears 122, 124, 126 such that the load-sharing planet gears 136, 138, planet gears 122, 124, 126, and the carrier 120 all revolve in unison about the center axis C1 during actuation.

In some embodiments, the first load-sharing planet gears 136 are identical to the first planet gears 122 and the second load-sharing planet gears 138 are identical to the second planet gears 124.

In some embodiments, the load sharing planet gear axes L1, L2, L3 are located at a first distance from the center axis C1 and the planet gear axes P1, P2, P3 are located at a second distance from the center axis C1. In the embodiments shown, the first distance is equal to the second distance. In another embodiment, the first distance is greater than the second distance. In other embodiments, the first distance is less than the second distance.

The array of load-sharing planet gear clusters 134 provides the compound epicyclic gear train with additional load paths at interfaces between the ring gears 114, 116 and the array of load-sharing planet gear clusters 134. The main purpose for the array of load-sharing planet gear clusters 134 is to reduce load exerted on the array of planet gear clusters 118 from the ring gears 114, 116 and distribute the load to the array of load-sharing planet gear clusters 134. The array of load-sharing planet gear clusters 134 are not necessary for the compound epicyclic gear train to function. This feature is particularly useful when the compound epicyclic gear train encounters high loads. The array of load-sharing planet gear clusters 134 further provides the compound epicyclic gear train an ability to distribute load more evenly and between a greater number of load paths, reducing stress and risks of mechanical failures for each load path. Further, the additional load paths aid in distributing load in the event of a tooth breaking in any one of the moving ring gear 114, fixed ring gear 116, first planet gears 122, second planet gears 124, the first load-sharing planet gears 136, and the second load-sharing planet gears 138.

Referring back to FIGS. 8 and 9, movement of the array of load-sharing planet gear clusters 134 is driven by rotation of the carrier 120 about the center axis C1 in many embodiments, since the sun gear 112 is not in meshing engagement with the load-sharing planet gear clusters 134. In an alternative embodiment (not shown), the array of load-sharing planet gear clusters could also be driven similarly to the array of planet gear clusters 118. The sun gear 112 may further be defined as a first sun gear 112 and the compound epicyclic gear train may comprise a second sun gear (not shown) rotatable about the center axis C1 and fixed to the first sun gear 112. The array of load-sharing planet gear clusters 134 may include third load-sharing planet gears (not shown) fixed to the first 136 and second 138 load-sharing planet gears to rotate with the first 136 and second 138 load-sharing planet gears about the load-sharing planet gear axes L1, L2, L3 and to revolve with the first 136 and second 138 load-sharing planet gears about the center axis C1. Each of the third load-sharing planet gears could be disposed in direct meshing relationship with the second sun gear. The array of load-sharing planet gear clusters 134 of the compound epicyclic gear train with the second sun gear configuration may resemble a mirror image of the array of planet gear clusters 118 spaced from the array of planet gear clusters 118.

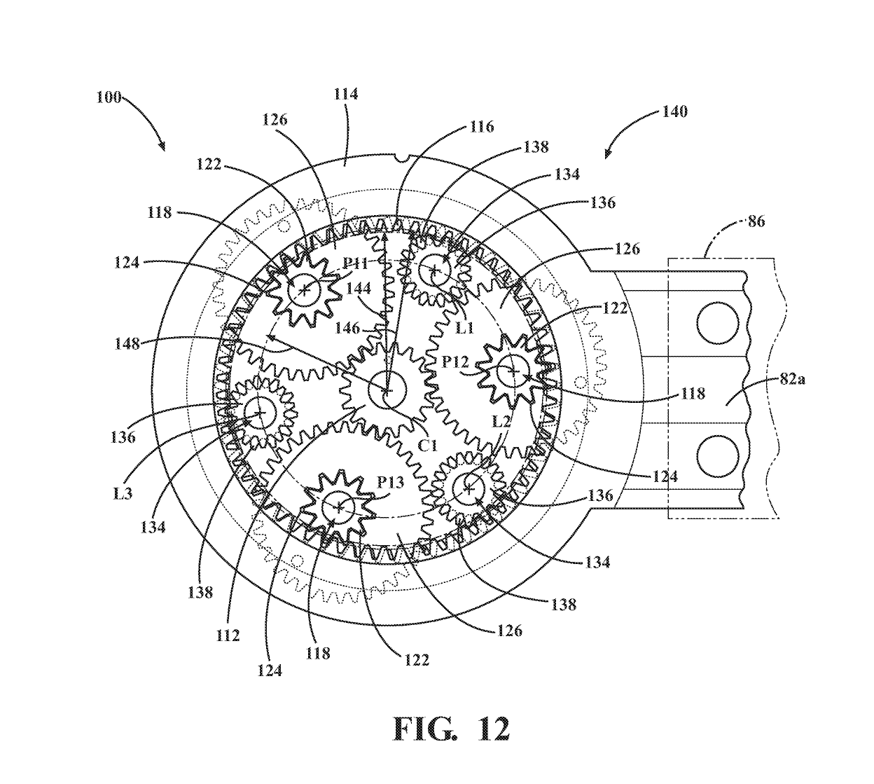

As shown in FIG. 12, each of the first planet gears 122 comprises a number of teeth, referenced as N_{FP}. The moving ring gear 114 comprises a number of teeth, referenced as N_{FR}. Each of the second planet gears 124 comprises a number of teeth, referenced as N_{SP}. The fixed ring gear 116 comprises a number of teeth, referenced as N_{SR}. A first ratio of N_{FR}/N_{FP} is different from a second ratio of N_{SR}/N_{SP}. This difference between the first ratio and the second ratio enables the actuator 78 to provide motion (or relative motion) of the movable member 86. In the embodiments shown, the gear assembly 100 enables rotation of the moving ring gear 114 relative to the fixed ring gear 116 if the first ratio is different from the second ratio.

In one embodiment, N_{FP} equals 11, N_{FR} equals 60, N_{SP} equals 11, and N_{SR} equals 57. Thus, N_{FR} is different than N_{SR} in the embodiment shown. Further, the moving ring gear 114 has more teeth than the fixed ring gear 116, e.g., three more teeth. In some embodiments, the moving ring gear 114 has four more teeth than the fixed ring gear 116. In other embodiments, the moving ring gear 114 has one or two more teeth than the fixed ring gear 116. It should be appreciated that the differences in the number of teeth between the moving ring gear 114 and the fixed ring gear 116 could widely vary, depending on the application and specific configuration of the gear assembly 100 desired. In other embodiments, the fixed ring gear 116 has more teeth than the moving ring gear 114, or the same number of teeth, such as in cases in which the first 122 and second 124 planet gears have different numbers of teeth.

In embodiments where the first 122 and second 124 planet gears have the same number of teeth, whether the moving ring gear 114 has more teeth than the fixed ring gear 116 or the fixed ring gear 116 has more teeth than the moving ring gear 114, will determine which direction the moving ring gear 114 rotates relative to rotation of the sun gear 112.

Referring to FIG. 12, each of the third planet gears 126 comprises a number of teeth, referenced as N_{TP}. In many embodiments, N_{TP} is greater than N_{FP} and N_{SP}. In one embodiment N_{TP} equals 38. In other embodiments N_{TP} has at least fifty percent more teeth than N_{FP} and N_{SP}, at least one hundred percent more teeth than N_{FP} and N_{SP}, at least two hundred percent more teeth than N_{FP} and N_{SP}, or at least three hundred percent more teeth than N_{FP} and N_{SP}. The large difference between N_{TP} and N_{FP}, N_{SP} provides a desirable gear ratio and also enables a smaller diameter sun gear 112 to drive the first 122 and second 124 planet gears while maintaining a desired distance of the first 122 and second 124 planet gears from the center axis C1, as described further below.

In embodiments using third planet gears 126, particularly third planet gears 126 that are larger than the first 122 and second 124 planet gears, the sun gear 112 does not directly interface with either of the first 122 or second 124 planet gears. In this configuration the sun gear 112 drives the third planet gears 126 and only directly interfaces with the third planet gears 126 of the compound epicyclic gear train. Another advantage this configuration offers is not requiring various tooth design parameters of the sun gear 112 to match the tooth design parameters of any of the first planet gears 122, second planet gears 124, the moving ring gear 114, or the fixed ring gear 116. Tooth design parameters may include but are not limited to pressure angle, diametrical pitch, and line of action.

Referring to FIG. 12, the teeth of the moving ring gear 114 are located at a first distance 144 from the center axis C1 and the teeth of the fixed ring gear 116 are located at a second distance 146 from the center axis C1. In one embodiment, the first distance 144 is greater than the second distance 146. In another embodiment, the first 144 and second 146 distances are equal. In still another embodiment, as shown in FIG. 12, the second distance 146 is greater than the first distance 144. In another embodiment, the second distance 146 is different than the first distance 144 by ten percent or less.

The first 122 and second 124 planet gears couple the moving ring gear 114 to the fixed ring gear 116. Each of the planet gear axes P11, P12, P13 is spaced from the center axis C1 at a third distance 148 wherein the third distance 148 is seventy percent of the first distance 144. Reducing the difference in distance from the center axis C1 between the first 144 and third 148 distances results in a very high stiffness between the moving 114 and fixed 116 ring gears. One advantage of high stiffness between the ring gears 114, 116 is reducing the angular deflection between the moving 114 and fixed 116 ring gears, providing increased structural integrity. In other embodiments, the third distance 148 is greater than fifty percent of the first distance 144, greater than sixty percent of the first distance 144, greater than seventy percent of the first distance 144, or greater than eighty percent of the first distance 144. In still another embodiment, the third distance 148 is from fifty percent to eighty percent of the first distance 144.

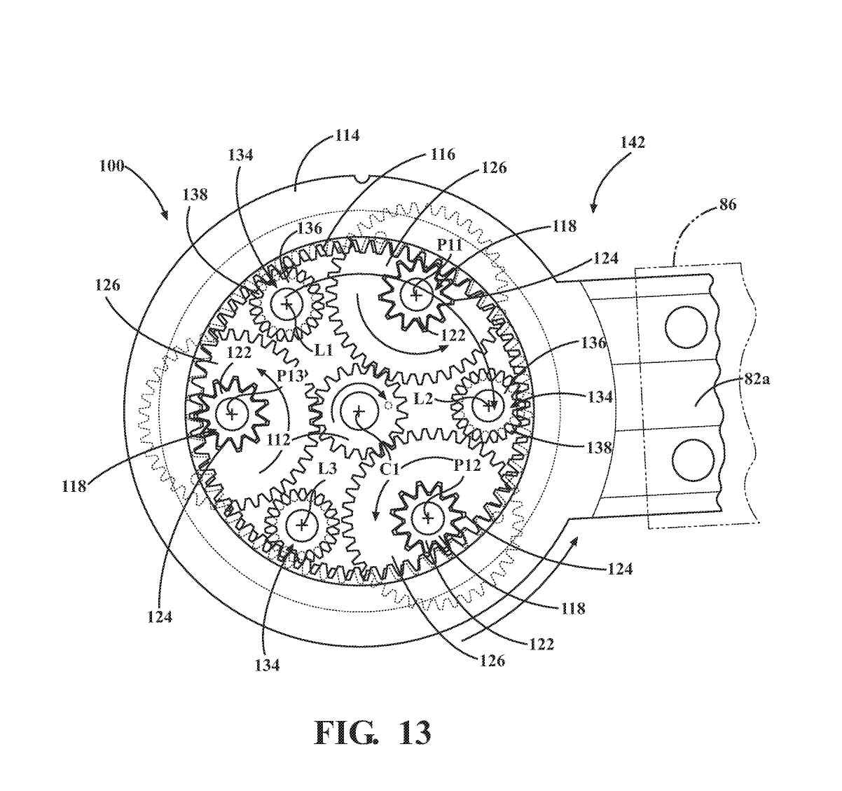

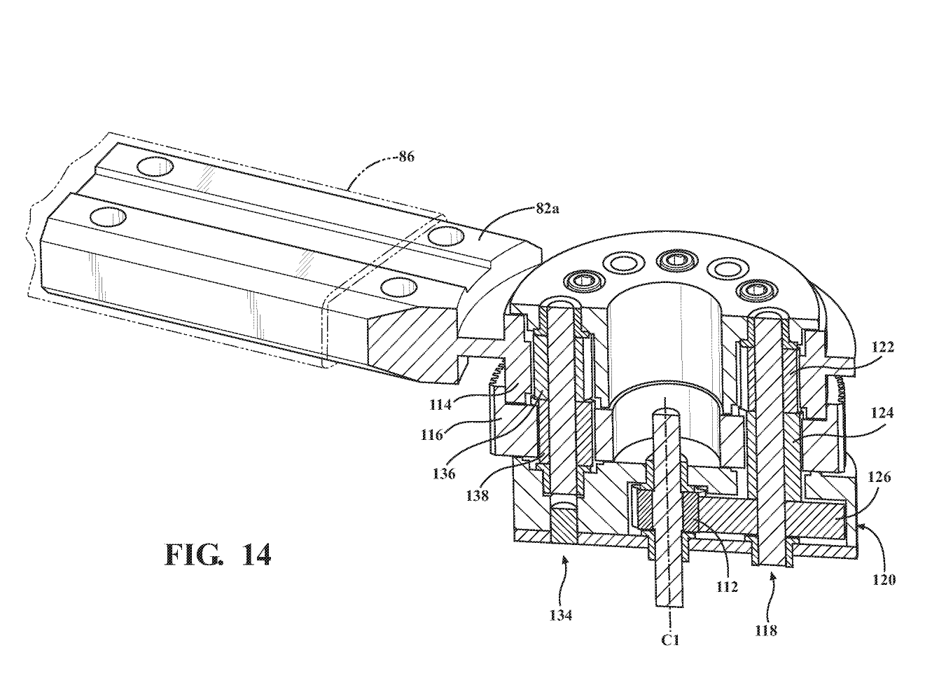

Each of the first planet gears 122 has a first planet gear diameter (radius for determining diameter is measured from a center of the planet gear to an imaginary circumference defined by the furthermost points on the teeth of the planet gear) and each of the second planet gears 124 has a second planet gear diameter. In one embodiment, the second planet gear diameter is different than the first planet gear diameter (see, e.g., FIGS. 12 and 13). In another embodiment, the diameters of the first 122 and second 124 planet gears are the same. In other words, the pinion radius of the first planet gears 122 may be the same as or different than the pinion radius of the second planet gears 124.

The first planet gear 122 has a physical configuration different from the second planet gear 124 to enable the planet gears 122, 124 to be placed on the same planet gear axis at the same distance from the center axis C1 while maintaining desired interfacing with their respective ring gears 114, 116. The difference in configuration may be attributed to one of tooth geometry, planet gear diameter, number of teeth, profile shift, extended/reduced addendums or dedendums, tooth depth, trichoid design, tooth alignment between gears, or any other physical quality a gear may have, and any combination thereof. Additionally, the first load-sharing planet gear 136 has a different physical configuration than the second load-sharing planet gear 138. In the embodiment shown, the first load-sharing planet gear 136 is oriented with respect to the second load-sharing planet gear 138 so that the teeth of the respective load-sharing planet gears 136, 138 are misaligned. Conversely, the teeth of the planet gears 122, 124, albeit of different diameters, are aligned. This is due to the ring gears 114, 116, in the embodiment shown, differing in number of teeth by three. In other embodiments, the teeth of the planet gears 122, 124 may be misaligned while the teeth of the load-sharing planet gears 136, 138 are aligned.

The motor 92 is configured to rotate the sun gear 112 about the center axis C1, which rotates the first 122, second 124, and third 126 planet gears about their respective planet gear axes P11, P12, P13 and revolves the arrays of planet gear clusters 118, 134 (and by extension the carrier 120) about the center axis C1, which rotates the moving ring gear 114 relative to the fixed ring gear 116 about the center axis C1 and moves the movable member 86 relative to the base 54. This configuration is referred to as forward drive and the gear assembly 100 is forward driven.

As shown in FIGS. 12 and 13, a progression of the compound epicyclic gear train using forward drive is illustrated. Clockwise and counter-clockwise directions are relative directions and refer to rotation of individual components of the compound epicyclic gear train with respect to the view shown in FIGS. 12 and 13. A first state 140 of the compound epicyclic gear train is shown in FIG. 12. A second state 142 of the compound epicyclic gear train is shown in FIG. 13.

Referring to FIG. 13, the sun gear 112 is rotated clockwise from the first state 140 to the second state 142 of the compound epicyclic gear train. Clockwise rotation of the sun gear 112 about the center axis C1 causes counter clockwise rotation of the first 122, second 124, and third 126 planet gears about their respective planet gear axes P11, P12, P13 and a clockwise revolution of the arrays of planet gear clusters 118, 134 about the center axis C1 by virtue of their meshing engagement with the fixed ring gear 116. Finally, clockwise rotation of the sun gear 112 causes counter-clockwise rotation of the moving ring gear 114 about the center axis C1. The direction the moving ring gear 114 moves relative to rotation of the sun gear 112 is a function of the number of teeth each ring gear 114, 116 comprises, as mentioned above. The degree to which the sun gear 112, arrays of planet gear clusters 118, 134, and moving ring gear 114 rotate is dependent on gear ratio.

The gear assembly 100 is back driven when a load is applied externally to the movable member 86, which creates torque in opposition to the driving forward torque that, if not checked, would otherwise rotate (in an opposite direction to their forward driving direction): the moving ring gear 114 relative to the fixed ring gear 116; the first 122, second 124, and third 126 planet gears about their respective planet gear axes P11, P12, P13 (causing reverse revolution of the arrays of planet gear clusters 118, 134 about the center axis C1); and the sun gear 112 about the center axis C1.

The gear assembly 100 has a forward drive efficiency and a back drive efficiency. The forward drive efficiency defines a proportion of forward drive output power to forward drive input power when the forward drive input power is applied to the input member 102 (e.g., the sun gear 112) by the motor 92 and the forward drive output power is available at the output member 104 (e.g., the moving ring gear 114) in response to the forward drive input power.

The back drive efficiency defines a proportion of back drive output power to back drive input power wherein the back drive input power (e.g., the torque caused by the external load) is applied to the output member 104 and the back drive output power is available at the input member 102 in response to the back drive input power. Generally, in compound epicyclic gear trains, lower forward drive efficiency results in lower back drive efficiency.

In this embodiment, the forward drive efficiency is greater than the back drive efficiency. In one embodiment, the forward drive efficiency is 0.5 or less and the back drive efficiency is 0.0 or less. When this occurs, the gear assembly 100 may not be back driven. Said differently, when the back drive efficiency is 0.0 or less, the gear assembly 100 does not permit rotation of the moving ring gear 114 in either direction unless forward driven. The compound epicyclic gear train is designed to have gear losses such that the forward drive efficiency is less than 0.5 and the back drive efficiency is less than 0.0.

Providing the gear assembly 100 with back drive efficiency of 0.0 or less has many advantages. One advantage is regardless of power applied to the output member 104 (e.g., torque caused by the external loads), the input member 102 will not rotate in response. This advantage is particularly beneficial for patient support apparatus applications. Returning to the fowler section 82 embodiment as an example, movement of the fowler section 82 is at least partially dependent on power being supplied to the motor 92 rather than as a result of a load being applied to the fowler section 82 such as via weight of a patient on the fowler section 82 or the fowler section 82 being manipulated by a patient. As another example, in the event the patient support apparatus 50 is being transported and the fowler section 82 collides with an external object, the fowler section 82 would not move from the position the fowler section 82 was in prior to the collision. Other advantages include not requiring an external braking solution to be coupled to the compound epicyclic gear train or requiring the motor 92 to have an internal braking solution. Either of the external braking solution and the internal motor braking solution may be necessary in the event that the compound epicyclic gear train is back drivable. It should be appreciated that brakes could still be employed as a redundant safety mechanism.

As previously described, the patient support apparatus 50 may have numerous devices that comprise one or more movable members that need to be moved to perform a desired function. The actuator 78 described can be used to cause movement of such movable members. Although the actuator 78 could be used in many different types of devices present on the patient support apparatus 50, only a few, non-limiting, additional examples are illustrated for convenience.

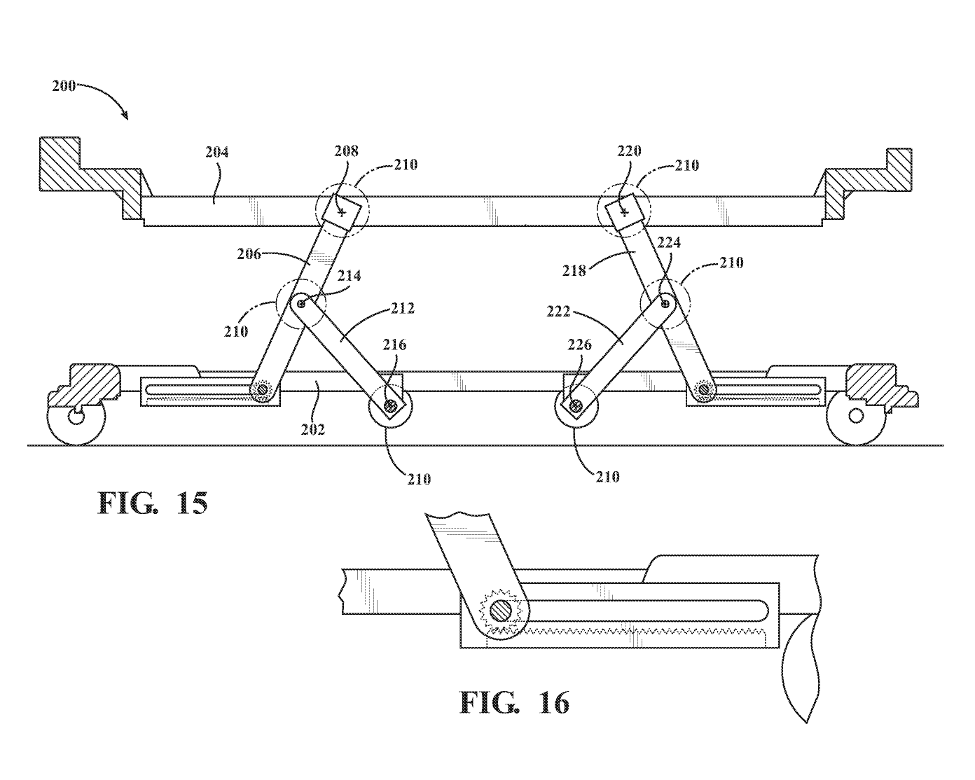

Referring to FIGS. 15-20, the actuator 78 described above may be used for application in a lift system 200. The actuator 78 is hereinafter referenced as actuator 210. The lift system 200 is coupled to a base 202 and an intermediate frame 204 and moves the intermediate frame 204 relative to the base 202 between a raised position, a lowered position, and one or more positions therebetween.

In one embodiment shown in FIG. 15, the lift system 200 comprises a head end lifting arm 206 pivotally coupled to the intermediate frame 204 at a head end joint 208 and slidably coupled to the base 202. The lift system 200 further comprises a first timing arm 212 pivotally coupled to the head end lifting arm 206 at a head end arm joint 214 and pivotally coupled to the base 202 at a head end base joint 216. The lift system 200 additionally comprises a foot end lifting arm 218 pivotally coupled to the intermediate frame 204 at a foot end joint 220 and slidably coupled to the base 202. The lift system 200 further comprises a second timing arm 222 pivotally coupled to the foot end lifting arm 218 at a foot end arm joint 224 and pivotally coupled to the base 202 at a foot end base joint 226. It should be appreciated that although reference is made to only a single head end lifting arm 206, a single foot end lifting arm 218, a single first timing arm 212, and a single second timing arm 222, multiples of such arms could also be employed.

In this embodiment, two actuators 210 are utilized for raising and lowering the intermediate frame 204 relative to the base 202. More specifically, one actuator 210 is coupled to one of the head end joints 208, 214, 216 and another actuator 210 is coupled to one of the foot end joints 220, 224, 226.

In another embodiment, more than two actuators 210 are coupled to the head end joints 208, 214, 216 and the foot end joints 220, 224, 226 as long as at least one actuator 210 is coupled to one of the head end joint 208, 214, 216 and at least one actuator 210 is coupled to one of the foot end joints 220, 224, 226.

In one embodiment, one actuator 210 is coupled to the head end joint 208 and another actuator 210 is coupled to the foot end joint 220. The head end lifting arm 206 is a movable member and the actuator 210 coupled to the head end joint 208 drives movement of the head end lifting arm 206 relative to the intermediate frame 204. The foot end lifting arm 218 is another movable member and the actuator 210 coupled to the foot end joint 220 drives movement of the foot end lifting arm 218 relative to the intermediate frame 204. The actuator 210 coupled to the head end joint 208 and the actuator 210 coupled to the foot end joint 220 operate in concert to raise and lower the intermediate frame 204 relative to the base 202 so that the intermediate frame 204 remains horizontal and parallel with a floor surface. In an alternative embodiment, one of the actuators 210 may drive movement of one of the movable members to raise and lower either the head end or the foot end such that the intermediate frame 204 does not remain horizontal with the floor surface. In further embodiments, the actuators 210 can be driven at different speeds to provide Trendelenburg or reverse Trendelenburg movement.

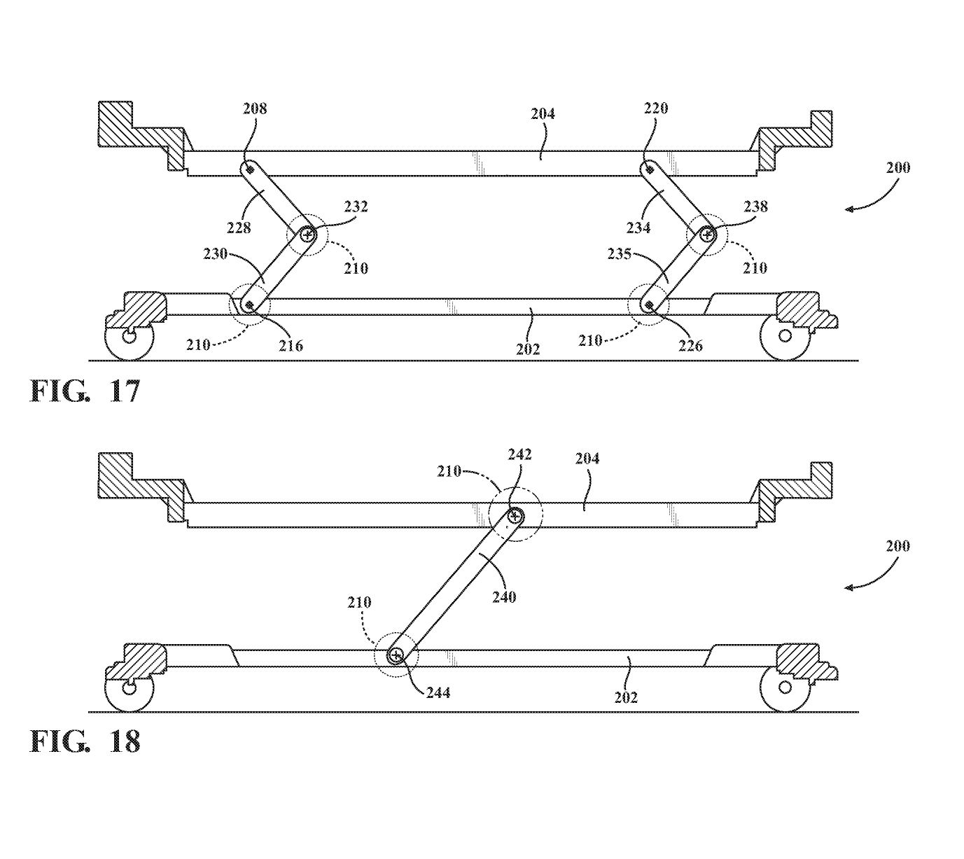

In another embodiment shown in FIG. 17, the lift system 200 comprises a head end upper arm 228 pivotally coupled to the intermediate frame 204 at the head end joint 208 and a head end lower arm 230 pivotally coupled to the base 202 at the head end base joint 216. The head end upper arm 228 is pivotally coupled to the head end lower arm 230 at a head end middle joint 232. The lift system 200 further comprises a foot end upper arm 234 pivotally coupled to the intermediate frame 204 at the foot end joint 220 and a foot end lower arm 235 pivotally coupled to the base 202 at the foot end base joint 226. The foot end upper arm 234 is pivotally coupled to the foot end lower arm 235 at a foot end middle joint 238. It should be appreciated that although reference is made to only a single head end upper arm 228, a single head end lower arm 230, a single foot end upper arm 234, and a single foot end lower arm 235, multiples of such arms could also be employed.

The lift system comprises multiple actuators 210. One actuator 210 is coupled to each of the head end middle joint 232, the foot end middle joint 238, the head end base joint 216, and the foot end base joint 226. One of the head end upper 228 lower 230 arms is a movable member and one of the foot end upper 234 and lower 235 arms is another movable member. The actuator 210 coupled to the head end middle joint 232 drives movement of the head end upper 228 and lower 230 arms relative to each other. The actuator 210 coupled to the foot end middle joint 238 drives movement of the foot end upper 234 and lower 235 arms relative to each other. The actuator 210 coupled to the head end base joint 216 drives movement of the head end lower arm 230 relative to the base 202. The actuator 210 coupled to the foot end base joint 226 drives movement of the foot end lower arm 235 relative to the base 202. The actuators 210 in this embodiment, operate in concert to raise and lower the intermediate frame 204 relative to the base 202. In an alternative embodiment, one of the actuators 210 may drive movement of one of the movable members to raise and lower either the head end or the foot end such that the intermediate frame 204 does not remain horizontal with the floor surface. In further embodiments, the actuators 210 can be driven at different speeds to provide Trendelenburg or reverse Trendelenburg movement.

In another embodiment shown in FIG. 18, the lift system 200 comprises a center lifting arm 240 pivotally coupled to the intermediate frame 204 at a top joint 242 and pivotally coupled to the base 202 at a bottom joint 244. It should be appreciated that although reference is made to only a single center lifting arm 240 multiple center lifting arms 240 could also be employed. In this embodiment, two actuators 210 are utilized for raising and lowering the intermediate frame 204 relative to the base 202. More specifically, one actuator 210 is coupled to the top joint 242 and another actuator 210 is coupled to the bottom joint 244. The center lifting arm 240 is a movable member for both actuators 210 and the intermediate frame 204 is a movable member for the actuator 210 at the top joint 242 (to control Trendelenburg and reverse Trendelenburg positioning). The actuators 210 drive movement of the center lifting arm 240 relative to the intermediate frame 204 and base 202 and work in concert to raise and lower the intermediate frame 204 relative to the base 202. Alternatively, one of the actuators 210 may drive movement, while the other actuator 210 remains stationary to raise and lower either the head end or the foot end such that the intermediate frame 204 does not remain horizontal with the floor surface. In further embodiments, the actuators 210 can be driven at different speeds to provide Trendelenburg or reverse Trendelenburg movement.

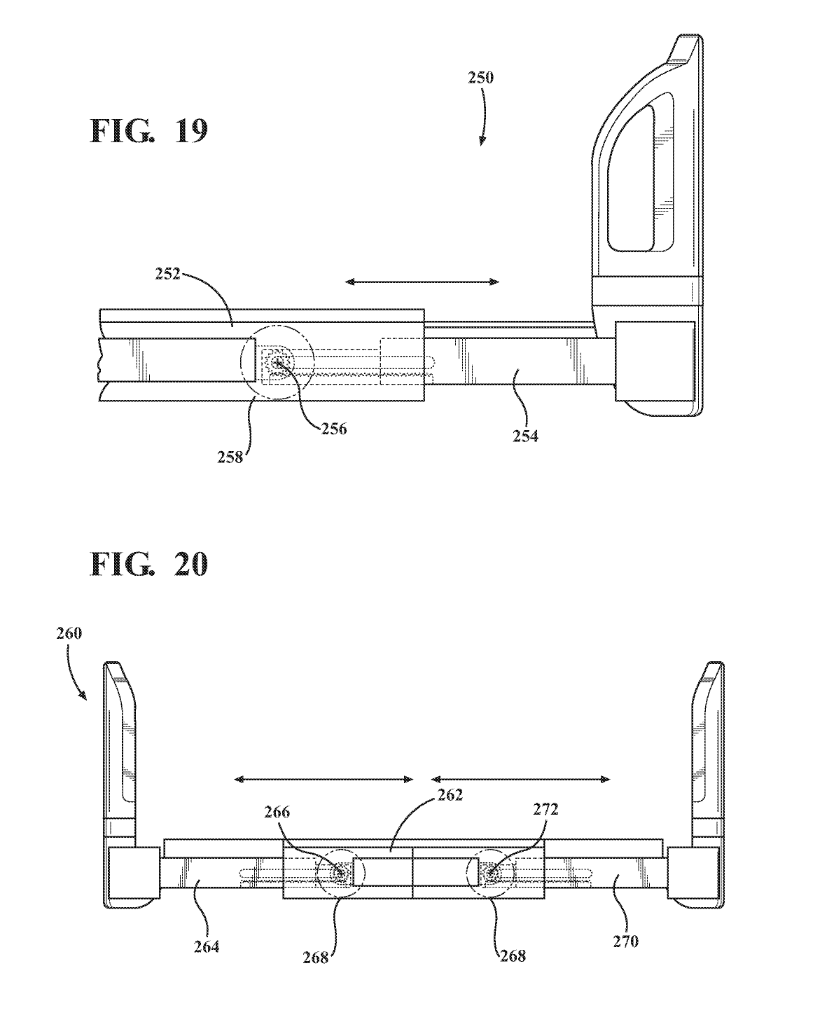

In another embodiment shown in FIG. 19, the actuator 78 described above may be used for application in a bed length extension device 250. The actuator 78 is hereinafter referenced as actuator 258. The bed length extension device 250 comprises a support frame 252 coupled to an extending member 254 at a joint 256. The bed length extension device 250 adjusts a length of the patient support apparatus 50 to accommodate patients of greater than average height. The actuator 258 is coupled to the support frame 252 and the extending member 254 and drives movement of the extending member 254 relative to the support frame 252 e.g., by driving a gear that slides a toothed rack fixed to the extending member 254. Thus, moving the extending member 254 away from the support frame 252 to lengthen the patient support apparatus 50.

In another embodiment shown in FIG. 20, the actuator 78 described above may be used for application in a bed width extension device 260. The actuator 78 is hereinafter referenced as actuator 268. The bed width extension device 260 comprises a support frame 262 coupled to a first extending member 264 at a first joint 266. The bed width extension device 260 further comprises a second extending member 270 coupled to the support frame 262 at a second joint 272. The bed width extension device 260 adjusts a width of the patient support apparatus 50 to accommodate patients of greater than average width. One actuator 268 is coupled to the first joint 266 and drives movement of the first extending member 264 relative to the support frame 262 (e.g., by driving a first gear that slides a first toothed rack fixed to the first extending member 264). Another actuator 268 is coupled to the second joint 272 and drives movement of the second extending member 270 relative to the support frame 262 (e.g., by driving a second gear that slides a second toothed rack fixed to the second extending member 270). The first 264 and second 270 extending members move away from the support frame 262 to widen the patient support apparatus 50. In one embodiment, only one of the actuators 268 drives movement of one of the extending members 264, 270 away from the support frame 262.

In another embodiment, the actuator 78 described above may be used anywhere in the patient support apparatus 50 including driving wheels, side rails, footboard, headboard, or any other movable component of the patient support apparatus 50. The gears and other components of the actuator 78 could be formed of metal, plastic, other suitable materials, or combinations thereof. Likewise, the movable members 86 could be formed of metal, plastic, other suitable materials, or combinations thereof.

It is to be appreciated that the terms “include,” “includes,” and “including” have the same meaning as the terms “comprise,” “comprises,” and “comprising.”

Several embodiments have been discussed in the foregoing description. However, the embodiments discussed herein are not intended to be exhaustive or limit the invention to any particular form. The terminology which has been used is intended to be in the nature of words of description rather than of limitation. Many modifications and variations are possible in light of the above teachings and the invention may be practiced otherwise than as specifically described.

1. A patient support apparatus comprising:
a patient support surface;
a first member and a movable member, said movable member movable relative to said first member; and
an actuator coupled to said movable member to move said movable member relative to said first member, said actuator comprising:
a gear assembly having an input member, an output member connected to said movable member, and a gear arrangement operable between said input member and said output member; and
a motor configured to apply torque to said input member to rotate said output member through said gear arrangement,
said gear assembly having a forward drive efficiency and a back drive efficiency, wherein said forward drive efficiency is greater than said back drive efficiency.

2. The patient support apparatus of claim 1, wherein:
said forward drive efficiency defines a proportion of forward drive output power to forward drive input power when said forward drive input power is applied to said input member by said motor and said forward drive output power is available at said output member in response to said forward drive input power,
said back drive efficiency defines a proportion of back drive output power to back drive input power wherein said back drive input power is applied to said output member and said back drive output power is available at said input member in response to said back drive input power.

3. The patient support apparatus of claim 2, wherein said back drive efficiency is 0.0 or less and said forward drive efficiency is 0.5 or less.

4. The patient support apparatus of claim 1, wherein said input member, said output member, and said gear arrangement operable between said input member and said output member form a compound epicyclic gear train.

5. The patient support apparatus of claim 4, wherein said input member comprises a sun gear rotatable about a center axis, said output member comprises a first ring gear rotatable about said center axis, and said gear arrangement comprises a second ring gear disposed about said center axis and an array of planet gear clusters disposed in direct meshing relationship with each of said sun gear, said first ring gear, and said second ring gear.

6. The patient support apparatus of claim 5, wherein said compound epicyclic gear train comprises a carrier rotatable about said center axis, said carrier retaining said array of planet gear clusters in direct meshing relationship with each of said sun gear, said first ring gear, and said second ring gear.

7. The patient support apparatus of claim 6, wherein said array of planet gear clusters comprises first planet gears spaced from each other and rotatable about respective planet gear axes, each of said first planet gears disposed in direct meshing relationship with said first ring gear such that said first planet gears revolve about said center axis.

8. The patient support apparatus of claim 7, wherein said array of planet gear clusters comprises second planet gears rotationally fixed to said first planet gears to rotate with said first planet gears about said planet gear axes and to revolve with said first planet gears about said center axis, each of said second planet gears disposed in direct meshing relationship with said second ring gear.

9. The patient support apparatus of claim 8, wherein said array of planet gear clusters comprises two or more of said first planet gears and two or more of said second planet gears.

10. The patient support apparatus of claim 9, wherein said array of planet gear clusters comprises third planet gears rotationally fixed to said first and second planet gears to rotate with said first and second planet gears about said planet gear axes and to revolve with said first and second planet gears about said center axis, each of said third planet gears disposed in direct meshing relationship with said sun gear.

11. The patient support apparatus of claim 10, wherein said motor is configured to rotate said sun gear about said center axis, which rotates said planet gears about said planet gear axes and revolves said array of planet gear clusters about said center axis, which rotates said first ring gear relative to said second ring gear about said center axis and moves said movable member relative to said first member.

12. The patient support apparatus of claim 11, wherein:
each of said first planet gears comprises N_{FP} number of teeth and said first ring gear comprises N_{FR} number of teeth;
each of said second planet gears comprises N_{SP} number of teeth and said second ring gear comprises N_{SR} number of teeth, wherein N_{FR} is different than N_{SR}; and
said first ring gear has more teeth than said second ring gear.

13. The patient support apparatus of claim 12, wherein said first ring gear has at least two more teeth than said second ring gear.

14. The patient support apparatus of claim 12, wherein a first ratio of N_{FR}/N_{FP} is different from a second ratio of N_{SR}/N_{SP}.

15. The patient support apparatus of claim 12, wherein said teeth of said first ring gear are located at a first distance from said center axis and said teeth of said second ring gear are located at a second distance from said center axis.

16. The patient support apparatus of claim 15, wherein said second distance is different than said first distance.

17. The patient support apparatus of claim 16, wherein said second distance is different than said first distance by ten percent or less.

18. The patient support apparatus of claim 17, wherein said first and second planet gears couple said first ring gear to said second ring gear, each of said planet gear axes spaced from said center axis at a third distance wherein said third distance is seventy percent of said first distance or greater.

19. The patient support apparatus of claim 8, wherein each of said first planet gears has a first planet gear diameter and each of said second planet gears has a second planet gear diameter different than said first planet gear diameter.

20. The patient support apparatus of claim 9, wherein said compound epicyclic gear train comprises an array of load-sharing planet gear clusters.

21. The patient support apparatus of claim 1, wherein said movable member comprises one or more of a lift member, a patient support deck member, a bed length extension member, a bed width extension member, a wheel, a side rail, a footboard, or a headboard.

22. The patient support apparatus of claim 1, comprising a patient support deck having a base section and a movable section movable relative to said base section, wherein said actuator is mounted to said base section and said movable section comprises said movable member.

23. The patient support apparatus of claim 1, comprising a patient support deck having a fowler section and a seat section, wherein said actuator is mounted to said seat section and said fowler section comprises said movable member.

24. The patient support apparatus of claim 1, comprising a patient support deck having a foot section and a seat section, wherein said actuator is mounted to said seat section and said foot section comprises said movable member.

25. The patient support apparatus of claim 1, comprising a base, a support frame, a first lift member, and a second lift member movable relative to said first lift member to lift and lower said support frame relative to said base, wherein said actuator is mounted to one of said base, said support frame, said first lift member, and said second lift member.
